(19) United States
(12) Patent Application Publication
(10) Pub. No.: US 2026/0149226 A1
(43) Pub. Date: May 28, 2026

(54) SHIELDED CONNECTOR

(71) Applicant: SUMITOMO WIRING SYSTEMS, LTD., Mie (JP)

(72) Inventors: Keisuke KANEMURA, Mie (JP); Norihito HASHIMOTO, Mie (JP)

(21) Appl. No.: 19/395,790

(22) Filed: Nov. 20, 2025

(30) Foreign Application Priority Data
Nov. 25, 2024 (JP) 2024-204697

(51) Int. Cl. H01R 13/6594; H01R 12/70; H01R 12/71; H01R 13/405; H01R 13/504

(52) U.S. Cl. CPC H01R 13/6594; H01R 12/7082; H01R 12/712; H01R 13/405; H01R 13/5045

(57) ABSTRACT

A shielded connector includes: a dielectric made of a synthetic resin; an inner conductor configured to be fastened to a circuit board in a state of being formed in one piece with the dielectric; and an outer conductor configured to be fastened to the circuit board in a state of surrounding the dielectric, and the dielectric has a first protrusion and the second protrusion that are in contact with the outer conductor in a plastically deformed state. Since the inner conductor and the dielectric are formed in one piece with the outer conductor via the first protrusion and the second protrusion in a plastically deformed state, relative displacement between the inner conductor and the outer conductor is suppressed.

### CROSS-REFERENCE TO RELATED APPLICATIONS

This application is based on and claims priority from Japanese Patent Application No. 2024-204697, filed on Nov. 25, 2024, with the Japan Patent Office, the disclosure of which is incorporated herein in its entirety by reference.

### TECHNICAL FIELD

The present disclosure relates to a shielded connector.

### BACKGROUND

JP 2009-238621 A discloses a shielded connector for a printed circuit board. This shielded connector includes a resin inner housing, a terminal, and a metal outer conductor. The terminal is attached to the inner housing by press-fitting or insert molding. A lead portion of the terminal is fastened to a circuit pattern of the printed circuit board in a conductive manner. An outer shield shell covers the inner housing. A ground terminal of the outer shield shell is fastened to a ground pattern of the printed circuit board in a conductive manner. In this type of shielded connector, the lead portion of the terminal and the ground terminal of the outer shield shell are generally fastened to the printed circuit board by soldering.

### SUMMARY

In the shielded connector of JP 2009-238621 A, the terminal and the inner housing are formed in one piece with each other by press-fitting or insert molding. In this configuration, since the inner housing and the outer shield shell are assembled via an inner shield shell and an outer housing, a slight relative displacement may occur. Accordingly, the relative positional relationship between the outer shield shell and the terminal is not stable.

A shielded connector according to the present disclosure has been achieved in view of the above circumstances, and an object is to stabilize the relative positional relationship between an outer conductor and an inner conductor.

A shielded connector according to the present disclosure includes: a dielectric made of a synthetic resin; an inner conductor configured to be fastened to a circuit board in a state of being formed in one piece with the dielectric; and an outer conductor configured to be fastened to the circuit board in a state of surrounding the dielectric, wherein the dielectric has a protrusion that is in contact with the outer conductor in a plastically deformed state.

According to the present disclosure, it is possible to stabilize the relative positional relationship between an outer conductor and an inner conductor.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view showing a shielded connector of Embodiment 1, separated into a shielded terminal and a housing.

FIG. 2 is an exploded perspective view of the shielded terminal.

FIG. 3 is a perspective view of the shielded terminal.

FIG. 4 is a back view of the shielded terminal.

FIG. 5 is a cross-sectional view taken along line A-A in FIG. 4.

FIG. 6 is a cross-sectional view taken along line B-B in FIG. 4.

FIG. 7 is a cross-sectional view taken along line C-C in FIG. 4.

FIG. 8 is a cross-sectional view taken along line D-D in FIG. 4.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure will be listed and described. Any combination of the following embodiments is encompassed in the embodiments of the present invention as long as no contradiction arises.

(1) A shielded connector according to the present disclosure is as follows: a shielded connector including: a dielectric made of a synthetic resin; an inner conductor configured to be fastened to a circuit board in a state of being formed in one piece with the dielectric; and an outer conductor configured to be fastened to the circuit board in a state of surrounding the dielectric. The dielectric has a protrusion that is in contact with the outer conductor in a plastically deformed state. According to the configuration of the present disclosure, the inner conductor and the dielectric are formed in one piece with the outer conductor via a plastically deformed protrusion, thereby stabilizing the relative positional relationship between the outer conductor and the inner conductor.

(2) In the above (1), a configuration is possible in which, an outer surface of the dielectric includes a positioning surface and a looseness reduction surface facing in opposite directions with the inner conductor interposed therebetween. Preferably, the positioning surface is in surface contact with the outer conductor, and the protrusion is formed on the looseness reduction surface. According to this configuration, the orientations of the dielectric and the inner conductor relative to the outer conductor are stabilized by bringing the positioning surface of the dielectric in surface contact with the outer conductor. This can suppress change in the orientations of the dielectric and the inner conductor relative to the outer conductor when the shielded connector is subjected to vibration, for example.

(3) In the above (2), it is preferable that a press-fitting hole through which the inner conductor is accommodated is open in the looseness reduction surface, and the protrusions are respectively formed on opposite sides of a pair of non-open regions with the press-fitting hole interposed therebetween in the looseness reduction surface. According to this configuration, compared to a configuration in which protrusions are formed only on one of the pair of non-open regions, the orientation of the dielectric relative to the outer conductor is stable.

(4) In the above (3), it is preferable that the opening portion of the press-fitting hole in the looseness reduction surface has an elongated slit-shape, and in the pair of non-open regions, a plurality of the protrusions are arranged at intervals in the length direction of the opening portion. According to this configuration, compared to a configuration in which the protrusions are formed at only one location in each non-open region, the orientations of the dielectric and inner conductor relative to the outer conductor are stable.

(5) In the above (4), it is preferable that the non-open regions have an elongated shape extending along the opening portion, and two of the protrusions are disposed at opposite end portions of the non-open regions in the length direction. According to this configuration, the orientation of the dielectric relative to the outer conductor can be stabilized compared to a configuration in which the protrusions are only formed in regions other than the opposite ends of the non-open region.

(6) In the above (5), it is preferable that the protrusions each form an elongated rib extending along the opening portion. According to this configuration, it is possible to secure a large contact area between the protrusions and the outer conductor within a limited range in the non-open region, thereby effectively making it possible to suppress positional displacement between the dielectric and the outer conductor.

(7) In the above (2) to (6), it is preferable that the dielectric includes: a first accommodation portion including the positioning surface and the looseness reduction surface, and oriented such that a length direction thereof extends in a direction intersecting the circuit board, and a second accommodation portion protruding from the positioning surface at an opposite end portion of the first accommodation portion to the circuit board. Preferably, the protrusions are respectively disposed on the looseness reduction surface at opposite end portions of the first accommodation portion in the length direction. According to this configuration, the protrusions are arranged at two locations along the length direction of the first accommodation portion: one location is the same as the second accommodation portion, and the other location is different from the second accommodation portion. This can stabilize not only the orientation of the first accommodation portion relative to the outer conductor, but also the orientation of the second accommodation portion relative to the outer conductor.

(8) In the above (7), it is preferable that the outer conductor is constituted by a first shell surrounding the first accommodation portion and a second shell surrounding the second accommodation portion joined together, and the protrusions include a first protrusion that contacts the first shell and a second protrusion that contacts the second shell. According to this configuration, a single dielectric is in contact with both the first shell and the second shell via the first protrusion and the second protrusion. In this configuration, compared to a configuration in which the protrusions are in contact with only one of the first shell and the second shell, the contact region between the protrusions and the outer conductor is larger, thereby stabilizing the orientation of the dielectric relative to the outer conductor.

### Details of Embodiments of the Disclosure

### Embodiment 1

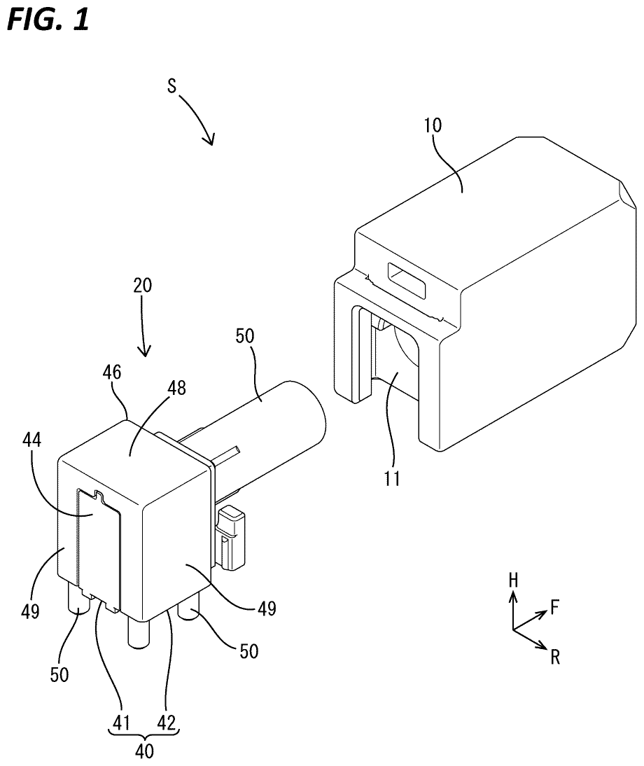

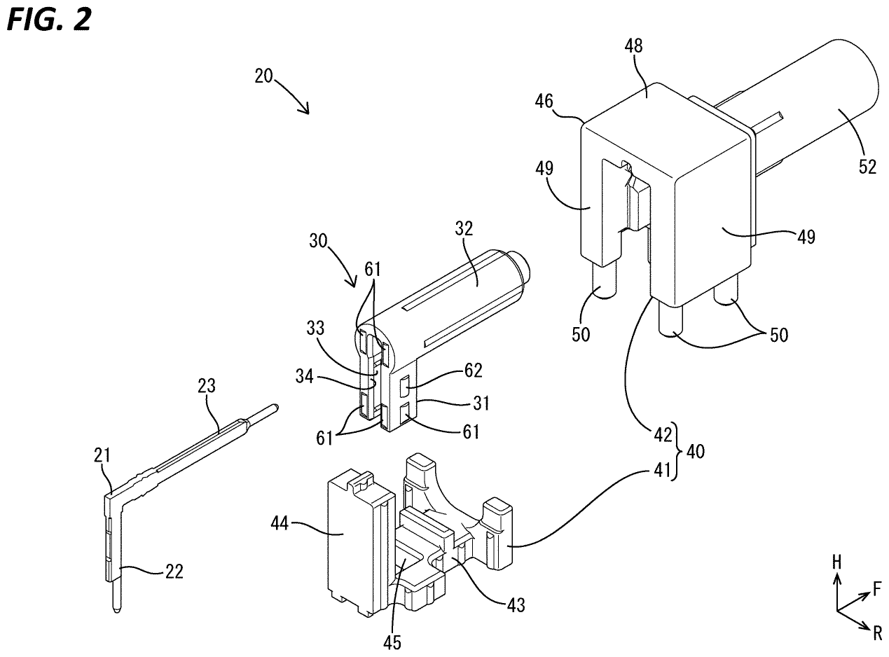

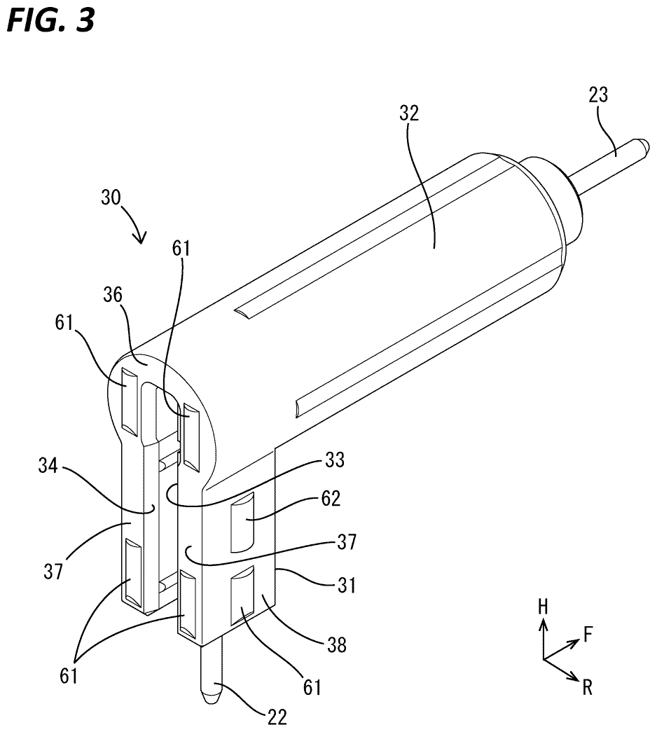

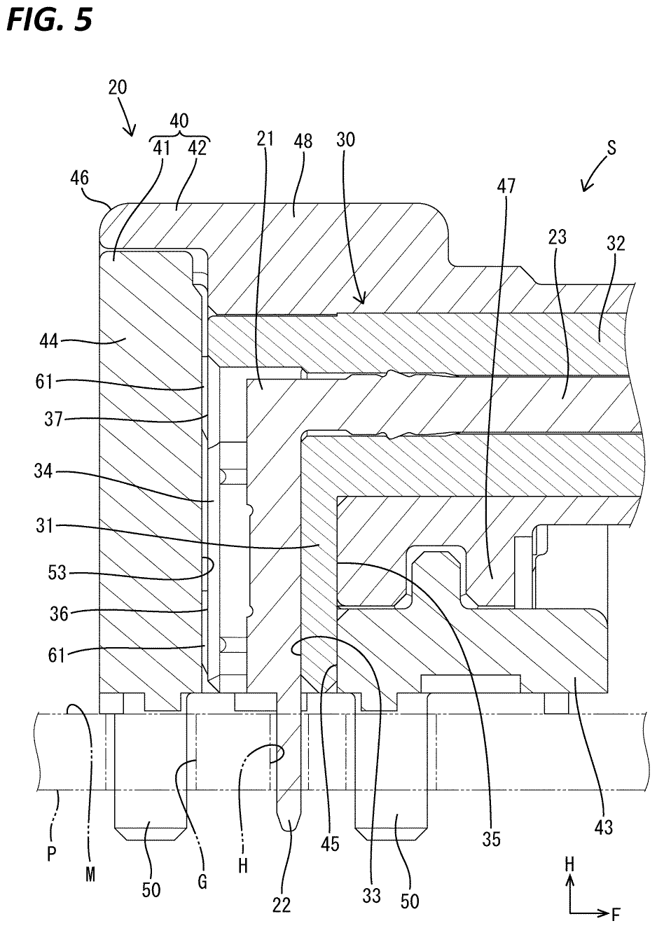

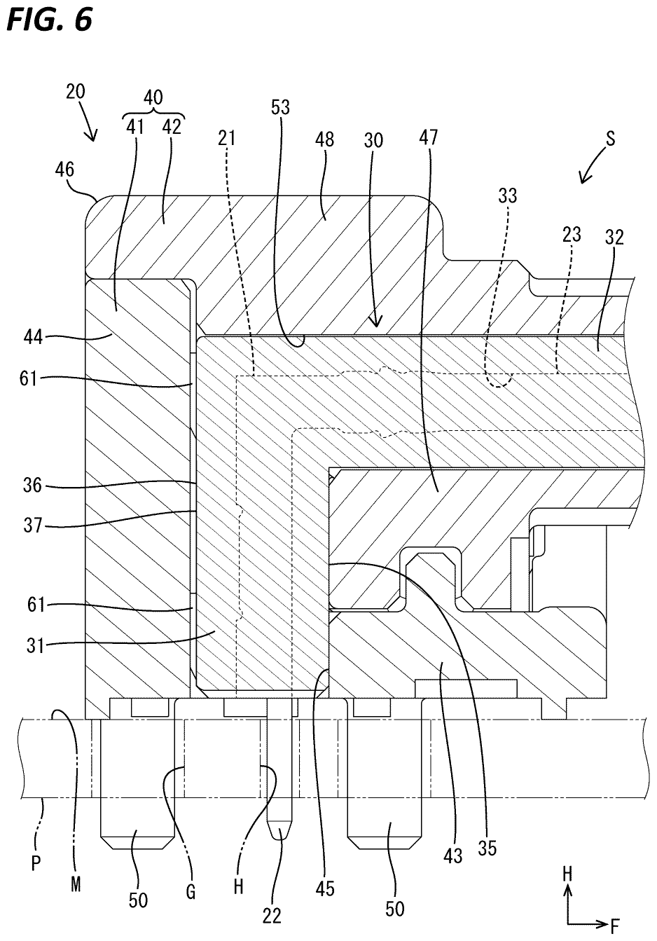

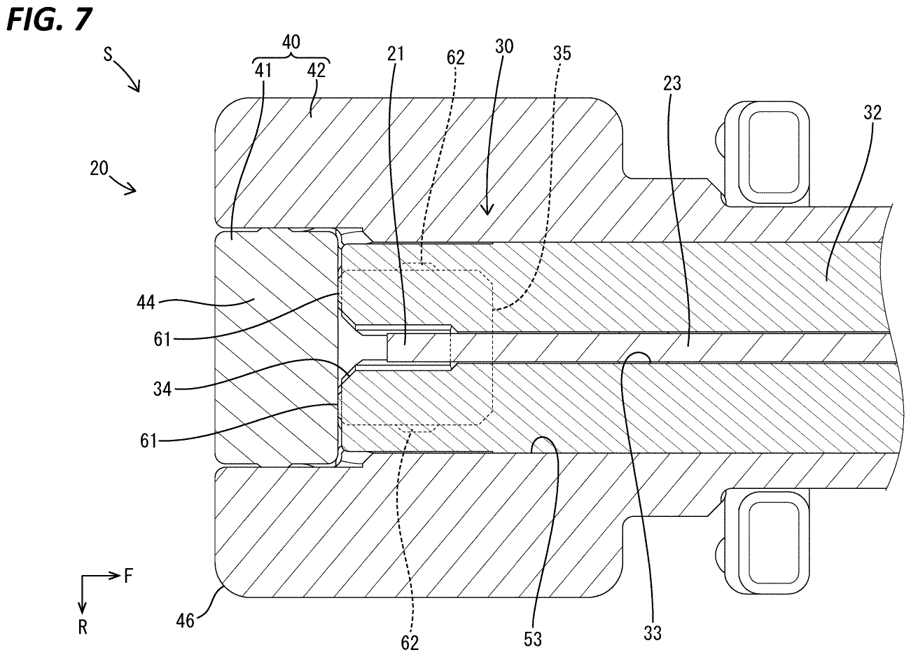

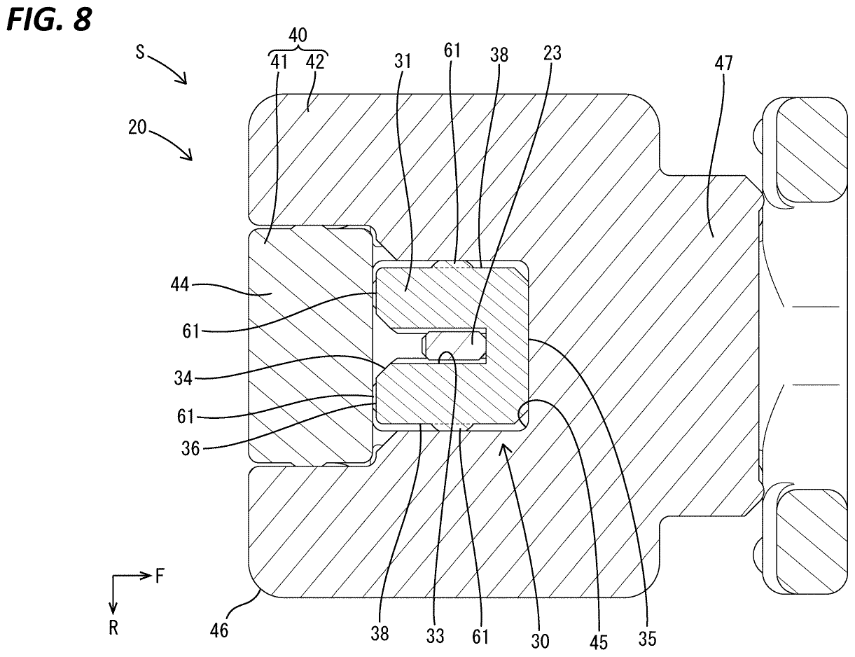

Hereinafter, a shielded connector S according to Example 1 that embodies the present disclosure will be described with reference to FIGS. 1 to 8. The present invention is not limited to these examples, but rather is indicated by the claims, and is intended to include all modifications within the meaning and scope equivalent to the claims. In this Example 1, with respect to the front-rear direction, a direction F in FIGS. 1 to 3 and FIGS. 5 to 8 is defined as forward. With respect to the up-down direction, an H direction in FIGS. 1 to 6 is defined as upward. With respect to the left-right direction, an R direction in FIGS. 1 to 4 and FIGS. 7 and 8 is defined as rightward.

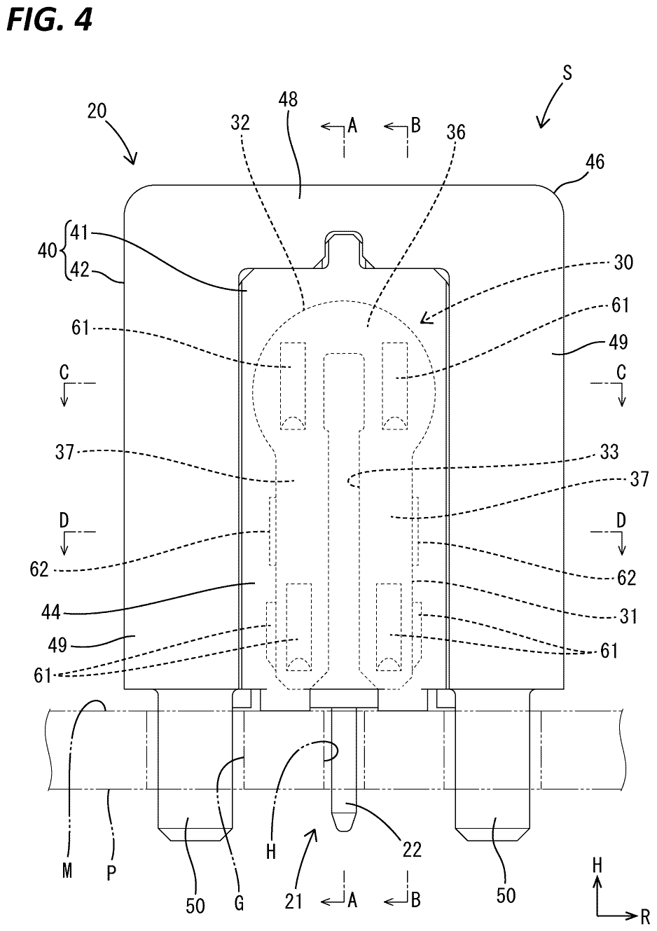

The shielded connector S of this Example 1 is mounted in a state of being placed on a mounting surface M of a circuit board P (see FIGS. 4 to 6) and fits to a counterpart connector (not shown) attached to a terminal portion of a wire harness (not shown). The shielded connector S is constituted by a housing 10 and a shielded terminal 20 assembled together. Inside the housing 10, a terminal accommodation chamber 11 is formed to accommodate the shielded terminal 20. The terminal accommodation chamber 11 is open in a rear and lower surfaces of the housing 10.

The shielded terminal 20 is constituted by an inner conductor 21, a dielectric 30, and an outer conductor 40 assembled together. In a side view of the shielded terminal 20, the inner conductor 21 is a single component that has a shape bent into an L-shape. The inner conductor 21 has a board connection portion 22 elongated in the up-down direction and a terminal connection portion 23 extending forward from the upper end of the board connection portion 22. A lower end portion of the board connection portion 22 is connected to a circuit board P. The terminal connection portion 23 is connected to a terminal fitting (not shown) of the counterpart connector.

Similarly to the inner conductor 21, the dielectric 30 has a shape bent into an L-shape. The dielectric 30 is a single component having a first accommodation portion 31 for accommodating the board connection portion 22 and a second accommodation portion 32 for accommodating the terminal connection portion 23. The first accommodation portion 31 has a prism shape elongated in the up-down direction. The second accommodation portion 32 is a cylindrical part that protrudes forward from an upper end portion of the first accommodation portion 31. The upper end portion of the first accommodation portion 31 has an arc-like shape concentric with the second accommodation portion 32. A press-fitting hole 33 for accommodating the inner conductor 21 is formed inside the dielectric 30. The press-fitting hole 33 is open in the rear and lower surfaces of the first accommodation portion 31 and a front end surface of the second accommodation portion 32. The inner conductor 21 is formed in one piece with the dielectric 30 by being pressed into the press-fitting hole 33 from the rear of the dielectric 30.

A front surface of the first accommodation portion 31 is formed by a single plane. The front surface of the first accommodation portion 31 is defined as a “positioning surface 35”. A rear surface of the first accommodation portion 31 is defined as a “first looseness reduction surface 36”. An opening portion 34 of the press-fitting hole 33 in the first looseness reduction surface 36 has a slit shape elongated in the up-down direction. The regions adjacent to the opening portion 34 on opposite sides of the first looseness reduction surface 36 in the left-right direction are defined as a pair of “non-open regions 37” that are symmetrical in the left-right direction. The non-open regions 37 are elongated in the up-down direction. Regions below an arc-like portion concentric with the second accommodation portion 32 on left and right outer side surfaces of the first accommodation portion 31 are defined as “second looseness reduction surfaces 38”.

The outer conductor 40 is constituted by a metal first shell 41 and a metal second shell 42 assembled together. The first shell 41 and the second shell 42 are components formed by casting, forging, cutting, or other means. The first shell 41 is a single component having a bottom wall portion 43 and a rear wall portion 44 protruding upward from a rear end of the bottom wall portion 43. A positioning hole 45 extends through the bottom wall portion 43 in the front-rear direction. In a plan view of the shielded connector S (the outer conductor 40) as seen from above, the opening of the positioning hole 45 has a square shape. The rear surface of the inner circumferential surface of the positioning hole 45 lies in the same plane as and is continuous with a front surface of the rear wall portion 44.

The second shell 42 is a single component having a box portion 46 and a tubular portion 52. The box portion 46 has a front wall portion 47, an upper wall portion 48, and a left and right pair of side wall portions 49. The upper wall portion 48 is a portion extending rearward from an upper edge of the front wall portion 47. The pair of side wall portions 49 are portions connected at right angles to the left and right edges of the front wall portion 47 and the left and right edges of the upper wall portion 48. The lower end portions of the side wall portions 49 protrude downward relative to the lower end of the front wall portion 47. The second shell 42 has a plurality (two pairs in this Example 1) of grounding connection portions 50 for connection to a ground circuit (not shown) of the circuit board P. The grounding connection portions 50 protrude downward from the front and rear end portions of the lower surface of each side wall portion 49. The tubular portion 52 is a part that protrudes forward from the front wall portion 47 with its axis directed in the front-rear direction. An inner space of the box portion 46 and an inner space of the tubular portion 52 communicate with each other. The inner space of the box portion 46 is open in the rear and lower surfaces thereof.

The outer conductor 40 is constituted by attaching the first shell 41 to the second shell 42 from below. The first shell 41 and the second shell 42 are formed in one piece by press-fitting. The portions to be press-fitted are, for example, between the left and right outer side surfaces of the rear wall portion 44 and the left and right inner side surfaces of the side wall portions 49, and between the left and right outer side surfaces of the bottom wall portion 43 and the left and right inner side surfaces of the side wall portions 49. In the state where the first shell 41 and the second shell 42 are attached together, the bottom wall portion 43 closes an opening portion in the lower surface of the box portion 46, and the rear wall portion 44 closes the opening portion in the rear surface of the box portion 46. An L-shaped accommodation space 53 for accommodating the dielectric 30 is formed inside the outer conductor 40. When the dielectric 30 is not accommodated, a front end of the accommodation space 53 is open in a front end surface of the tubular portion 52. A lower end of the accommodation space 53 is open in the lower surface of the bottom wall portion 43 at the positioning hole 45.

When assembling the shielded connector S, first the inner conductor 21 is pressed into the press-fitting hole 33 from the rear of the dielectric 30. The dielectric 30, into which the inner conductor 21 has been press-fitted, is accommodated in the internal space of the second shell 42 from the rear of the second shell 42. Next, the first shell 41 is attached to the second shell 42 such that the positioning hole 45 is fitted to the lower end portion of the first accommodation portion 31. When the first shell 41 and the second shell 42 are attached, the outer conductor 40 is formed, and at the same time, the dielectric 30 is accommodated in the accommodation space 53 of the outer conductor 40. In this manner, the assembly of the shielded terminal 20 is complete. By accommodating the assembled shielded terminal 20 inside the housing 10, the assembly of the shielded connector S is complete.

In the state where the shielded connector S has been mounted on the circuit board P, the grounding connection portions 50 of the outer conductor 40 are inserted into a grounding insertion hole G of the circuit board P and are fastened to the ground circuit (not shown) in a conductive manner by soldering. The board connection portion 22 of the inner conductor 21, which protrudes downward from the lower end surface of the first accommodation portion 31, is inserted into a through hole H of the circuit board P and is bonded to a printed circuit of the circuit board P in a conductive manner by soldering.

The lower end portion of the first accommodation portion 31 is fitted into the positioning hole 45 that is open in the bottom surface of the outer conductor 40 (first shell 41). Due to the dimensional tolerances of the first accommodation portion 31 and the first shell 41, there is a concern that the first accommodation portion 31 and the board connection portion 22 may be displaced in the front-rear direction or the left-right direction within the positioning hole 45, or that looseness may occur. To counter this, the dielectric 30 (first accommodation portion 31) has the positioning surface 35, a plurality of first protrusions 61, and a plurality of second protrusions 62.

The first protrusions 61 are parts that come in intimate contact with the first shell 41 of the outer conductor 40. The first protrusions 61 are arranged at six locations: the upper and lower end portions of the pair of non-open regions 37 (first looseness reduction surfaces 36) and the lower end portions of the left and right second looseness reduction surfaces 38. The second protrusion 62 is a portion that comes in intimate contact with the second shell 42 of the outer conductor 40. The second protrusion 62 is disposed at the upper end portion of the left and right second looseness reduction surfaces 38. The two second protrusions 62 protrude from the second looseness reduction surfaces 38 in opposite directions in the left-right direction.

In a plan view, the outer surfaces of the first protrusions 61 and the second protrusions 62 are arc-shaped. In a rear view of the dielectric 30 (shielded connector S), the first protrusions 61 are elongated in the up-down direction. In a side view of dielectric 30, the first protrusions 61 and the second protrusions 62 are elongated in the up-down direction. The longitudinal direction of the first protrusions 61 is parallel to a direction in which the dielectric 30 and the first shell 41 are assembled together.

In the state where the outer conductor 40 and the dielectric 30 have been assembled, the positioning surface 35 is in surface contact with the inner surface of the outer conductor 40 (accommodation space 53) from the rear. Specifically, the lower end region of the positioning surface 35 is in intimate contact with the front surface of the inner circumferential surface of the positioning hole 45 from the rear. The upper end region of the positioning surface 35 is in intimate contact with the rear surface of the front wall portion 47 of the second shell 42 from the rear. The two first protrusions 61 located at the lower end portion of the first looseness reduction surface 36 (non-open region 37) are in intimate contact with the rear surface of the inner circumferential surface of the positioning hole 45 from the front. The first protrusions 61 of the positioning surface 35 and the non-open regions 37 are brought into intimate contact with the inner surface of the positioning hole 45 (first shell 41) in the front-rear direction, thereby positioning the lower end portions of the first accommodation portion 31 and the inner conductor 21 in the front-to-back direction relative to the first shell 41.

In the state where the outer conductor 40 and the dielectric 30 have been assembled together, the two first protrusions 61 located at the lower end potion of the second looseness reduction surfaces 38 are in intimate contact with the left and right inner surfaces of the positioning hole 45 in the left and right direction in the inner circumferential surface. The two second protrusions 62 located at the upper end portion of the second looseness reduction surfaces 38 are in intimate contact with the inner surfaces of the left and right side wall portions 49 of the second shell 42 in the left-right direction and from opposite directions to each other. The first protrusions 61 and the second protrusions 62 are in intimate contact with the side wall portions 49, thereby positioning the first accommodation portion 31 in the left-right direction with respect to the outer conductor 40. The two first protrusions 61 located at the upper end portion of the first looseness reduction surfaces 36 (non-open regions 37) are brought into intimate contact with a front surface of the rear wall portion 44 of the first shell 41 from the front.

The first protrusions 61 and the second protrusions 62 are plastically deformed due to interference with the outer conductor 40 during the process of assembling the dielectric 30 and the outer conductor 40, and come into intimate contact with the outer conductor 40 in a pressed state. Due to the contact between the positioning surface 35 and the outer conductor 40, and the intimate contact between the first and the second protrusions 61 and 62 and the outer conductor 40 in the pressed state, the lower end portions of the first accommodation portion 31 and the board connection portion 22 are positioned in the positioning hole 45 in a two-dimensional direction (front-rear direction and left-right direction) parallel to the mounting surface M of the circuit board P. This keeps the outer conductor 40 and the inner conductor 21 in the desired positional relationship on the mounting surface M of the circuit board P.

The shielded connector S in this Example 1 includes the dielectric 30 made of a synthetic resin, the inner conductor 21, and the outer conductor 40. The inner conductor 21 is bonded to the circuit board P in one piece with the dielectric 30. The outer conductor 40 is bonded to the circuit board P while surrounding the dielectric 30. The dielectric 30 has the first protrusions 61 and the second protrusions 62 formed so as to be in contact with the outer conductor 40 in a plastically deformed state. According to this configuration, the inner conductor 21 and the dielectric 30 are formed in one piece with the outer conductor 40 via the first protrusions 61 and the second protrusions 62 which have been plastically deformed, thereby suppressing relative displacement between the inner conductor 21 and the outer conductor 40. This stabilizes the relative positional relationship between the outer conductor 40 and the inner conductor 21. Furthermore, when the shielded connector S is subjected to vibration and the like, stress concentration can be suppressed at the bonding portions between the inner conductor 21 and the circuit board P and between the outer conductor 40 and the circuit board P due to relative displacement between the inner conductor 21 and the outer conductor 40.

The outer surface of the dielectric 30 has the positioning surface 35 and the first looseness reduction surface 36. The positioning surface 35 and the first looseness reduction surface 36 are positioned so as to sandwich the inner conductor 21, and face each other from opposite directions in the front-rear direction. The positioning surface 35 comes in surface contact with the first shell 41 and second shell 42 of the outer conductor 40. The first protrusions 61 are formed on the first looseness reduction surface 36. According to this configuration, by bringing the positioning surface 35 of the dielectric 30 into surface contact with the outer conductor 40, the orientations of the dielectric 30 and the inner conductor 21 relative to the outer conductor 40 are stable. This prevents the orientation of the dielectric 30 and the inner conductor 21 relative to the outer conductor 40 from changing when the shielded connector S is subjected to vibration and the like.

The press-fitting hole 33 through which the inner conductor 21 is accommodated is open in the first looseness reduction surface 36. The first protrusions 61 are respectively formed on the pair of non-open regions 37 on the opposite sides of the opening portion 34 of the press-fitting hole 33 in the first looseness reduction surface 36, in the left-right direction. According to this configuration, compared to a configuration in which a protrusion is formed only on one of the pair of non-open regions 37, the orientation of the dielectric 30 relative to the outer conductor 40 is stable.

The opening portion 34 of the press-fitting hole 33 in the first looseness reduction surface 36 has a slit-like shape elongated in the up-down direction. In the pair of non-open regions 37, the plurality of first protrusions 61 are arranged at intervals in the length direction of the opening portion 34. According to this configuration, compared to a configuration in which the protrusion is formed at only one location in each non-open region 37, the orientations of the dielectric 30 and the inner conductor 21 relative to the outer conductor 40 are stable.

Each non-open region 37 has a shape elongated in the up-down direction along the opening portion 34. The two first protrusions 61 are respectively arranged at opposite end portions of the non-open region 37 in the length direction. According to this configuration, compared to a configuration in which the formation position of the protrusions is set only in the regions other than the opposite end portions of the non-open region 37, it is possible to stabilize the orientation of the dielectric 30 with respect to the outer conductor 40.

The first protrusion 61 and the second protrusion 62 form elongated ribs extending along the opening portion 34. According to this configuration, it is possible to secure a large contact area between the first protrusion 61 and the outer conductor 40, and between the second protrusion 62 and the outer conductor 40, within a limited range in the non-open regions 37, thereby effectively suppressing positional displacement between the dielectric 30 and the outer conductor 40.

The dielectric 30 has the first accommodation portion 31 and the second accommodation portion 32. The first accommodation portion 31 has the positioning surface 35 and the first looseness reduction surface 36. The first accommodation portion 31 is oriented such that the length direction thereof extends in the up-down direction intersecting the circuit board P. The second accommodation portion 32 protrudes forward from the positioning surface 35 at the opposite end portion of the first accommodation portion 31 to the circuit board P. The first protrusions 61 are respectively disposed at opposite end portions of the first accommodation portion 31 in the length direction of the first looseness reduction surface 36. According to this configuration, the first protrusions 61 are arranged at two locations along the length direction of the first accommodation portion 31: one location is the same as the second accommodation portion 32; and the other location is different from the second accommodation portion 32. This stabilizes not only the orientation of the first accommodation portion 31 relative to the outer conductor 40, but also the orientation of the second accommodation portion 32 relative to the outer conductor 40.

The outer conductor 40 is constituted by the first shell 41 surrounding the first accommodation portion 31 and the second shell 42 surrounding the second accommodation portion, which are joined together. The protrusions include the first protrusions 61 that come into contact with the first shell 41, and the second protrusions 62 that come into contact with the second shell 42. According to this configuration, one dielectric 30 is in contact with both the first shell 41 and the second shell 42 via the first protrusions 61 and the second protrusions 62. According to this configuration, compared to a configuration in which the protrusions are in contact with only one of the first shell 41 and the second shell 42, the contact region of the protrusion with respect to the outer conductor 40 becomes larger, thereby stabilizing the orientation of the dielectric 30 with respect to the outer conductor 40.

### Other Examples

The present invention is not intended to be limited to the embodiments described using the above descriptions and drawings, and is indicated by the claims. The scope of the present invention includes all changes within the meaning and scope equivalent to the scope of the claims, including embodiments described below.

The dielectric does not need to have a positioning surface that comes in surface contact with the outer conductor. In this case, a protrusion can be formed on the outer surface corresponding to the positioning surface.

Protrusions may be formed on only one of the two non-open regions on the looseness reduction surfaces.

The protrusions in each non-open region may be formed at only one or three or more locations.

The protrusions may be disposed only in a region other than the end portions of the non-open regions.

The shape of the protrusions is not limited to an elongated rib with an arc-like cross section, but may also be spherical or triangular rib in cross section.

The protrusions may also be configured to be in contact with only one of the first shell and the second shell.

The protrusions may be formed in both the first accommodation portion and the second accommodation portion, or may be formed only in the second accommodation portion.

The opening shape of the press-fitting hole in the looseness reduction surface is not limited to a slit shape, and may be a wide rectangular shape or the like.

The inner conductor and the dielectric may have shapes other than an L-shape.

The inner conductor may be formed in one piece with the dielectric by insert molding. In this case, the dielectric does not need to include a press-fitting hole, an opening portion, and a non-open region.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A shielded connector comprising:
a dielectric made of a synthetic resin;
an inner conductor configured to be fastened to a circuit board in a state of being formed in one piece with the dielectric; and
an outer conductor configured to be fastened to the circuit board in a state of surrounding the dielectric,
wherein the dielectric has a protrusion that is in contact with the outer conductor in a plastically deformed state.

2. The shielded connector according to claim 1,
wherein an outer surface of the dielectric includes a positioning surface and a looseness reduction surface facing in opposite directions with the inner conductor interposed therebetween,
the positioning surface is in surface contact with the outer conductor, and
the protrusion is formed on the looseness reduction surface.

3. The shielded connector according to claim 2,
wherein a press-fitting hole through which the inner conductor is accommodated is open in the looseness reduction surface, and
the protrusions are respectively formed on opposite sides of a pair of non-open regions with the press-fitting hole interposed therebetween in the looseness reduction surface.

4. The shielded connector according to claim 3,
wherein the opening portion of the press-fitting hole in the looseness reduction surface has an elongated slit-shape, and
in the pair of non-open regions, a plurality of the protrusions are arranged at intervals in the length direction of the opening portion.

5. The shielded connector according to claim 4,
wherein the non-open regions have an elongated shape extending along the opening portion, and
two of the protrusions are disposed at opposite end portions of the non-open regions in the length direction.

6. The shielded connector according to claim 5,
wherein the protrusions each form an elongated rib extending along the opening portion.

7. The shielded connector according to claim 2,
wherein the dielectric includes:
a first accommodation portion including the positioning surface and the looseness reduction surface, and oriented such that a length direction thereof extends in a direction intersecting the circuit board, and
a second accommodation portion protruding from the positioning surface at an opposite end portion of the first accommodation portion to the circuit board, and
the protrusions are respectively disposed on the looseness reduction surface at opposite end portions of the first accommodation portion in the length direction.

8. The shielded connector according to claim 7,
wherein the outer conductor is constituted by a first shell surrounding the first accommodation portion and a second shell surrounding the second accommodation portion joined together, and
the protrusions include a first protrusion that contacts the first shell and a second protrusion that contacts the second shell.
